(19) United States
(12) Patent Application Publication
(10) Pub. No.: US 2025/0353964 A1
(43) Pub. Date: Nov. 20, 2025

(54) PREPARATION OF ACID-FREE HYDROSILOXANE EQUILIBRATES

(71) Applicant: Evonik Operations GmbH, Essen (DE)

(72) Inventors: Wilfried Knott, Essen (DE); Horst Dudzik, Essen (DE)

(73) Assignee: Evonik Operations GmbH, Essen (DE)

(21) Appl. No.: 19/207,625

(22) Filed: May 14, 2025

(30) Foreign Application Priority Data
May 17, 2024 (EP) 24176573.4

(51) Int. Cl. C08G 77/12; B01J 39/05; B01J 39/19

(52) U.S. Cl. CPC C08G 77/12; B01J 39/05; B01J 39/19

(57) ABSTRACT

The invention relates to a process for preparing acid-free hydrosiloxane equilibrates. A mixture is contacted with a macrocrosslinked water-containing cation exchange resin that contains sulfonic acid groups and left to react with rearrangement of the SiOSi bonds until the acid-free hydrosiloxane equilibrate produced in this way, in a metal-catalysed hydrosilylating addition onto at least one unsaturated polyether affords an addition product that is clear at T=25° C. The rearrangement of the SiOSi bonds is implemented in the temperature range from 10 to 50° C. The cation exchange resin is characterized in that the product P of the specific surface area thereof and the average pore diameter thereof is P≥2.2×10⁻³ m³/kg and the specific surface area A is ≥35 m²/g, and in that it additionally has a water.

### CROSS-REFERENCE TO RELATED APPLICATIONS

This application is a new U.S. Patent Application which claims priority to European Patent Application No. 24176573.4, filed on May 17, 2024, the content is hereby incorporated by reference in its entirety.

### BACKGROUND OF THE INVENTION

### Field of the Invention

The invention is in the field of silicone chemistry and relates in particular to a process for preparing acid-free unbranched hydrosiloxane equilibrates.

### Description of Related Art

Hydrosiloxanes, i.e. siloxanes having SiH groups, in particular as equilibrates, play an important role as precursors, for example for further processing thereof to give polyethersiloxanes, silicone acrylates, silicone quats, silicone waxes and numerous other derivatives.

Equilibration of siloxanes is fundamentally known from the prior art. Aside from the oldest equilibration methods conducted by homogeneous catalysis, heterogeneously catalysed processes have in recent years increasingly become involved in industrial silicone production that makes use of solid-phase catalysts.

One example of a significant advantage of the acidic solid-phase catalyst in the production of hydrosiloxanes is that the liquid siloxane phase can be separated from the acidic solid-phase catalyst without complex aftertreatment, in particular without the neutralization of a homogeneous acid that is otherwise typically used with subsequent removal by filtration of the salt formed.

Among the solid-phase catalysts used for equilibration of hydrosiloxanes, particular significance attaches here to the macroporous sulfonic acid polystyrene resins. These are found to be particularly suitable for equilibration of siloxane systems having siloxane components that bear methylhydrosiloxy groups.

Following this objective, for example, the teaching of WO 2010/031654 A1 is guided in particular to the equilibration of poly(methylhydro)polydimethylsiloxane copolymers over a water-containing cation exchange resin, wherein an organosiloxane used as starting material or an organosiloxane mixture at a temperature of 10° C. to 120° C. is contacted with a macrocrosslinked water-containing cation exchange resin that contains sulfonic acid groups, and the resultant equilibrated organosiloxanes are isolated. The water-containing cation exchange resin used according to WO 2010/031654 A1 is characterized in that the product P of the specific surface area thereof and the average pore diameter thereof is P≥2.2×10⁻³ m³/kg and the specific surface area A is >35 m²/g, and in that it additionally has a water content of 8 to 25 per cent by weight, based on the weight of the ion exchange resin. In order to counter depletion of water from the sulfonic acid cation exchange resin, WO 2010/031654 A1 teaches that it can be advantageous to add defined amounts of water to the reactant system.

WO 2010/074831 A1 describes a process for preparing siloxanes, comprising the converting of at least two siloxanes in the presence of an ion exchange resin catalyst comprising 6% to 19% by weight of water, wherein at least one of the siloxanes comprises a silicon-bonded hydrogen atom, and wherein preferably at least one of the siloxanes is poly(methyl)hydrosiloxane or a cyclic siloxane. In particular, this describes the reacting of at least two siloxanes over a water-containing ion exchange resin catalyst, wherein at least one siloxane comprises a silicon-bonded hydrogen atom and wherein the ion exchange resin catalyst is recovered after the reacting and a water loading of 6 to 19 per cent by weight based on the dry weight of the ion exchange resin catalyst is established by addition of water to the ion exchange resin catalyst, and then at least two siloxanes are converted again in the presence of that ion exchange resin catalyst. Reactants chosen in the examples of WO 2010/074831 A1 are octamethylcyclotetrasiloxane and tetramethyldisiloxane, and in that case the content of octamethylcyclotetrasiloxane (D₄) in the siloxane matrix at the end of the reaction that is determined by gas chromatography is considered to be an indicator of establishment of equilibrium. Moreover, a defined SiH content of the reaction mixture is referenced only at the start of the reaction. However, WO 2010/074831 A1 does not give any figures for the SiH content of the reaction mixture at the end of each reaction. Aside from the D₄ content determined via gas chromatography, however, the SiH content of the reaction product is of even greater importance since all the customary framework-building further reactions (for example hydrosilylation or else dehydrogenative reactions) require this reference parameter to fix the respective stoichiometry.

DE 102014211680 A1 describes the preparation of siloxanes, preferably with regeneration-free reuse of the ion exchange resins, comprising the reacting of at least two siloxanes over a sulfonic acid cation exchange resin, using at least one OH-functional siloxane. In the examples of DE 102014211680 A1, α,ω-dihydropolydimethylsiloxane and decamethylcyclopentasiloxane were used. In the context of the disclosure, it is shown there that a multitude of sulfonic acid cation exchange resins are suitable for the equilibration of α,ω-dihydropolydimethylsiloxanes that proceeds with SiOSi rearrangement. But while claiming the breadth of all acid-equilibratable siloxanes, the document does not show how to obtain equilibrated, i.e. very substantially equally distributed SiH siloxanes having both chain-terminal and pendant SiH functions.

The SiH function-conserving equilibration of siloxanes bearing both dimethylhydrosiloxy groups and methylhydrosiloxy units in the equilibration matrix constitutes the greatest challenge to date, and so superacids such as the perfluoroalkanesulfonic acids, especially trifluoromethanesulfonic acid and perfluorobutanesulfonic acid, are still the preferred homogeneous catalysts for the industrial equilibration of these particular hydrosiloxanes.

However, it is foreseeable that the possibility of utilizing the highly effective homogeneous catalysts already described will only be possible to a limited time horizon. European chemical legislation is currently working towards elimination of perfluorinated alkanesulfonic acids, and so it can currently be assumed that, for example, the homogeneous catalysts such as trifluoromethanesulfonic acid and perfluorobutanesulfonic acid, which are tried and tested in silicone production, will no longer be available in the future.

A difficulty in the equilibration of preferably unbranched hydrosiloxanes that bear dimethylhydrosiloxy groups but also still have methylhydrosiloxy groups and dimethylsiloxy groups lies in achieving a substantially statistical uniform distribution of SiH functions along the oligomer chain, without too many of the sensitive dimethylhydrosiloxy groups being lost as a result of dehydrogenative processes.

By comparison with perfluorinated superacids, the effective acidity of sulfonic acid ion exchange resins in siloxane matrices containing SiH groups is distinctly lower, and so it is very important when using sulfonic acid ion exchange resins to find the suitable reaction parameters for the respective equilibration system.

The required acidity is specifically guided here by the equilibration task to be achieved, i.e. by the structure of the desired hydrosiloxane. The synthesis of α,ω-dihydropolydimethylsiloxanes places the lowest demands on the acidity exerted by the catalyst, i.e. its ability to provide protons. If, for example, a mixture consisting of octamethylcyclotetrasiloxane and tetramethyldisiloxane is converted under acid catalysis to α,ω-dihydropolydimethylsiloxanes, it is theoretically the case that only one proton is needed for the opening of an octamethylcyclotetrasiloxane molecule, initiated by protonation of the oxygen atom in an SiOSi bond present therein. It is likewise the case that only one proton is theoretically required for the opening of the SiOSi bond present in the tetramethyldisiloxane molecule. Adjustment of the oligomer chain distribution additionally requires comparatively low protic activity.

However, the conditions are completely different in the case of those copolymeric siloxanes which contain methylhydrosiloxy units (D^{H} units) and dimethylsiloxy units (D units) in addition to trimethylsiloxy groups (M units) and which can be prepared, for example, from poly(methylhydro)siloxane and octamethylcyclotetrasiloxane and hexamethyldisiloxane under acid catalysis. Theoretically only one proton is needed for the opening of an octamethylcyclotetrasiloxane molecule after protonation of the oxygen atom in one of the four SiOSi bonds present therein. Likewise, only one proton is theoretically required for the initiation of the opening of the SiOSi bond present in the hexamethyldisiloxane molecule. Molecular decomposition of the poly(methylhydro)siloxane also theoretically requires only 1 proton for each siloxanyl bond (SiOSi bond). In order, however, to achieve a statistical distribution of the methylhydrosiloxy units along the oligomer chains of the desired poly(methylhydrosiloxane)-polydimethylsiloxane copolymer in the time window of the reaction, a far greater number of protons are needed per unit volume of reaction mass since only virtually simultaneous breaking and reforming of multiple SiOSi bonds results in a copolymer that does not have any cumulation(s) of methylhydrosiloxy units (=D^{H} units) within the siloxane oligomer chains.

The greatest challenge is considered to be controlled acid-catalysed preparation of hydrosiloxanes having dimethylhydrosiloxy units, methylhydrosiloxy units and dimethylsiloxy units, and preferably also fractions of trimethylsiloxy end groups. The aim here is to assure the widest possible statistical distribution of the methylhydrosiloxy units along the oligomer chains, but at the same time to ensure that especially the sensitive dimethylhydrosiloxy groups do not undergo any relevant loss of hydrogen.

In disclosing specifically this type of hydrosiloxane, the teaching of DE 102005001039 A1 is concerned with the establishment of a suitable equilibration equilibrium of specific sulfonic acid cation exchange resins, but without achieving a statistical distribution of the SiH functions in the hydrosiloxane obtained.

Specifically, DE 102005001039 A1 also describes a process for preparing SiH group-containing equilibration products of organosiloxanes by rearrangement of the siloxane bond over a sulfonic acid cation exchange resin, wherein an organosiloxane used as starting material or an organosiloxane mixture and hydrosiloxanes are contacted at a temperature of 10° C. to 120° C. with a macrocrosslinked cation exchange resin containing sulfonic acid groups, and the organosiloxanes thus obtained are isolated by using a cation exchange resin whose product P of the specific surface area thereof and the average pore diameter thereof is P<2.2×10⁻³ m³/kg and the specific surface area A is <50 m²/g.

In order to obtain nonstick coating compositions, DE 102005001039 A1 refers to the preparation of organopolysiloxanes containing (meth) acrylate groups and obtained by dehydrogenative conversion of (meth) acrylated alcohols, for example hydroxy ethyl acrylate, with these organosiloxanes that are essentially permeated by SiH domains and B (C₆F₅)₃ as catalyst.

For comparative purposes, E 102005001039 A1 cites hydrosiloxanes which, using decamethylcyclopentasiloxane (D₅), poly(methyl)hydrosiloxane and an α,ω-dihydropolydimethylsiloxane (HSiMe₂-[SiMe₂O]₈—SiMe₂H), have been admixed with 0.1% trifluoromethanesulfonic acid and equilibrated at 30° C. with constant stirring for 6 hours and then neutralized with Na₂CO₃.

However, these statistically uniformly distributed hydrosiloxanes that have been obtained under trifluoromethanesulfonic acid catalysis and the (meth) acrylate group-bearing derivatives thereof are unsuitable for the objective of DE 102005001039 A1.

Since, according to the teaching given therein, a statistical distribution of the SiH functions in the hydrosiloxane obtained is not an aim, it is not possible to infer any instruction from DE 102005001039 A1 that exactly specifies the cation exchange resins over which and the reaction conditions under which the preparation of the statistically uniformly distributed hydrosiloxanes of this structure type that are otherwise obtainable only under trifluoromethanesulfonic acid catalysis is possible.

EP 1 439 200 A1 describes a process for preparing equilibration products of organosiloxanes by rearrangement of the siloxane bond over a sulfonic acid cation exchange resin, wherein an organosiloxane used as starting material or an organosiloxane mixture are contacted at a temperature of 10° C. to 120° C. with a macrocrosslinked cation exchange resin containing sulfonic acid groups, and the resultant equilibrated organosiloxanes are isolated by using a cation exchange resin whose product P of the specific surface area thereof and the average pore diameter thereof is P≥2.2×10⁻³ m³/kg and the specific surface area A is ≥35 m²/g. In EP 1 439 200 A1, the starting material used is in particular a mixture of hexamethyldisiloxane, poly(methyl)hydrosiloxane and siloxane cycles. By way of example, one of the preparations described therein is that of a hydrosiloxane, using decamethylcyclopentasiloxane, poly(methyl)hydrosiloxane and hexamethyldisiloxane, by equilibration at a temperature of 95° C. The evaluation of nuclear-magnetic resonance spectra can permit the conclusion that the resulting products have predominantly individual SiH segments in statistical arrangement.

Published specification DE 21 52 270 A describes a process for preparing equilibration products of organosiloxanes by rearrangement of the siloxane bond over a cation exchange resin, wherein organosiloxane used as starting material or an organosiloxane mixture is allowed to flow at a temperature of about 10° C. to about 100° C. through a packing containing, as cation exchange resin, a macrocrosslinked cation exchange resin containing sulfonic acid groups and having an average pore volume of at least about 0.01 cm³, and the eluted organosiloxanes are isolated. Among the findings described therein is that it is possible to use a mixture of methylhydrosiloxane, dimethylsiloxane and an organosiloxane from the group of hexamethyldisiloxane and symmetrical tetramethyldisiloxane. One of the possibilities described therein is that of preparing copolymeric dimethylsiloxane poly(methyl)hydrosiloxanes by equilibrating a mixture consisting of methylhydropolysiloxane, hexamethyldisiloxane and siloxane cycles over the macrocrosslinked Amberlyst® 15 ion exchanger phase.

EP 2 628 763 A1 discloses a process for preparing branched polysiloxanes having olefinically unsaturated groups and SiH groups, preferably using an acidic ion exchange resin having sulfonic acid groups.

For the preparation of the hydrosiloxanes composed of dimethylhydrosiloxy units, methylhydrosiloxy units and dimethylsiloxy units and possibly fractions of trimethylsiloxy end groups, however, no technical instruction is given, since on the one hand they have methylhydrosiloxy units, which are more robust with respect to SiH losses, but on the other hand they also have dimethylhydrosiloxy units, which undergo severe SiH losses even under relatively moderate conversion conditions.

Against this background, by the inventors' assessment, none of the documents cited in the prior art teaches how equilibrated hydrosiloxanes having SiH groups statistically distributed therein and having both pendant SiH in the form of methylhydrosiloxy groups and dimethylhydrosiloxy and dimethylsiloxy groups, and preferably having fractions of trimethylsiloxy end groups, are produced in a reproducible manner and with very substantial conservation in particular of the hydrogen originating from the dimethylhydrosiloxy groups with utilization of a sulfonic acid cation exchange resin.

This purely statistical-theoretical consideration of the acidity required for the equilibration of such siloxane copolymers is experimentally supported by the publication by G. Sauvet, M. Moreau, G. Hélary, E. Daudet, P. Cancouet, “Functional polysiloxanes. I. Microstructure of poly(hydrogenmethylsiloxane-co-dimethylsiloxane) s obtained by cationic copolymerization” in J. Polymer Science, Part A: Polymer Chemistry Vol. 38, 826-36 (2000), in which the authors (on page 833, ibid.) come to the clear conclusion that a siloxane bond (SiOSi) between two D^{H} units is less reactive than that between two D units, which directly influences the part-reactions, such as backbiting, crosslinking and acidolysis, that are involved in acidic equilibration.

The cumulation of methylhydrosiloxy groups should be avoided as far as possible, since the subsequent usefulness of the hydrosiloxane equilibrates in hydrosilylation reactions, particularly in those in which polyether mixtures are used to obtain polyethersiloxanes for demanding surfactant applications, for example as stabilizer in polyurethane foams, is linked directly to the structural feature of copolymers that has polyether-bearing Si atoms distributed over the oligomer chains as randomly as possible, i.e. isolated from one another as far as possible, because they are separated from one another by D units.

Sauvet et al. (page 835, right-hand column, ibid.), in their above-cited publication, reach the conclusion that knowledge of the distribution of D and D^{H} units in the chain is the key to understanding the properties of the (SiH) copolymers per se and even more so the properties of the functionalized derivatives derived therefrom. Sauvet et al. point to the direct influence of the distribution of D and D^{H} units in the chain on the speed of reaction in hydrosilylation reactions.

In this context, P. Cancouet, S. Pernin, G. Helary, G. Sauvet, in their article “Functional polysiloxanes. II. Neighboring effect in the hydrosilylation of poly(hydrogenmethylsiloxane-co-dimethylsiloxane)s by allylglycidylether” in J. Polymer Science, Part A: Polymer Chemistry, Vol. 38, 837-45 (2000), investigated the neighbouring group effect in the hydrosilylating addition of allyl glycidyl ether onto poly(methylhydrosiloxane)-polydimethylsiloxane copolymers and demonstrated that the presence of methylhydrosiloxy diads (D_{H}-D_{H}) leads to accelerated hydrosilylation, while isolated D^{H} units, i.e. those surrounded by D units, (D-D_{H}-D) exhibit slower reaction kinetics. Against the background of this finding, it is apparent to those skilled in the art that the microstructure of the hydrosiloxanes, particularly in the case of the addition of polyether mixtures with their range of individual reactivities, has a significant influence on the subsequent target structure of the polyethersiloxane copolymer.

Methods for determining the molecular fine structure in hydrosiloxanes are known. For instance, G. Sauvet et al. in the publication already cited, J. Polymer Science, Part A: Polymer Chemistry Vol. 38, 826-36 (2000), used high-resolution ²⁹Si NMR spectroscopy in particular to detect diads, triads, pentads, etc., i.e. cumulations of methylhydrosiloxy groups, in a poly(methylhydrosiloxane)-polydimethylsiloxane copolymer.

However, NMR technology as an in-process analysis method, specifically as a real-time method, has not found a place to date in the industrial production of polyorganohydrosiloxanes, this being due to factors including the costs for the equipment to be installed but in particular also the fundamental problem of accommodating sources of extremely strong electromagnetic radiation, such as NMR magnets and measurement heads, in an operationally safe manner in explosion-protected production plants.

The teaching of WO 2022/132446 A1 seeks to address the question of in-process analysis by using, specifically supported by examples therein, vibrational spectroscopic methods such as infrared spectroscopy and Raman spectroscopy to determine structures directly linked to one another (D^{H}-D^{H}) and mutually separated structures (D-D^{H}-D) in the acid-catalysed equilibration of siloxanes acting as D source and siloxanes acting as D^{H} source in order to assess the degree of distribution achieved. Focussing on the curing rate in siloxane elastomers, a direct relationship is seen between the concentration of decoupled, i.e. statistically distributed, SiH groups determined by vibrational spectroscopy and the curing kinetics when using the respective SiH copolymer. For example (ibid. page 18, Table 3), an SiH copolymer from Batch 1, after and equilibration time of 3 hours and a SiH IR intensity of 2.08 introduced into an elastomer system, needs 144.3 seconds for through-curing, whereas an SiH copolymer originating from Batch 7, after an equilibration time of 16 hours and with a measured SiH IR intensity of 3.32, already leads to curing of the elastomer system after only 61.4 seconds. Addressing a wide variety of different curing systems (condensation- and/or hydrosilylation-curable products) in particular as target products, the method presented in WO 2022/132446 A1 is said to help to minimize batch times and simultaneously to achieve higher statistical uniformity of the equilibrated SiH copolymer.

### SUMMARY OF THE INVENTION

Preferably with regard to high-level silicone polyether copolymers that may find use in rigid polyurethane foam stabilizers, for example, this present invention is concerned, inter alia, with the providing of particular acid-free hydrosiloxane equilibrates and preferably also, inter alia, with the detection of very substantially statistical uniform distribution of SiH functionality in hydrosiloxanes having both pendant SiH in the form of methylhydrosiloxy groups and dimethylhydrosiloxy groups and dimethylsiloxy groups, and preferably also fractions of trimethylsiloxy groups. This provision of particular acid-free hydrosiloxane equilibrates and preferably also detection of very substantially statistical uniform distribution of SiH functionality was the specific object of the present invention. What is meant by statistical uniform distribution of SiH functionality in the context of the invention is that all methylhydrosiloxy groups present in the reaction system are distributed over the chains of the hydrosiloxane equilibrate such that, averaged over the entire chain length distribution of the hydrosiloxane, there is preferably neither underpopulated nor overpopulated presence of methylhydrosiloxy groups, and that cumulation, meaning adjacent arrangement of methylhydrosiloxy groups in the siloxane chains, is preferably very substantially avoided.

It has now been found by the inventors that, astonishingly, said acid-free hydrosiloxane equilibrates can be prepared over a macrocrosslinked, water-containing cation exchange resin that contains sulfonic acid groups, where said cation exchange resin is characterized in that the product P of the specific surface area thereof and the average pore diameter thereof is P≥2.2×10⁻³ m³/kg and the specific surface area A is ≥35 m²/g, and in that it additionally has a water content of 6 to 16 per cent by weight, preferably of 8 to 12 per cent by weight, based on the weight of the cation exchange resin.

The inventors have further found that, astonishingly, the person skilled in the art, without having to use the above-described complex instrumental analysis, is able to make a reliable assessment merely by visual inspection of selected polyethersiloxanes as to whether the equilibration reaction conducted in the respective hydrosiloxane mixture has led to a very substantially statistically uniformly distributed copolymer or else—at the hydrosiloxane stage—one permeated by methylhydrosiloxy domains.

These findings are surprising and unforeseeable to the person skilled in the art since the old patent literature concerned with the equilibrating incorporation of dimethylhydrosiloxy groups into differently structured siloxane skeletons disclosed that hydrogen losses of Si-bonded hydrogen (SiH) that were considerable in some cases are recorded when cation exchange resins of exactly that type are used for that purpose. For example, working examples 2, 3 and 4 of EP 2 628 763 A1 thus very clearly show the SiH losses undergone by an equilibration system based on the use of dimethylhydro groups over a sulfonic acid cation exchange resin (Lewatit® K 2621). In that case, the sulfonic acid resin with a water content of 10% is left to act at 40° C. for 6 hours on a mixture consisting of a branched and a linear hydrosiloxane, each of which contain the sensitive dimethylhydrosiloxy groups, and siloxanes having only 66%, 82% and 75% of the amount of SiH originally used are isolated.

Achievement of the above-specified specific object is enabled by the subject-matter of the present invention. The present invention provides a process for preparing acid-free hydrosiloxane equilibrates of the following average structural formula:

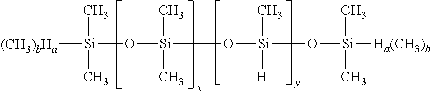

where

$$3 \leq x \leq 100 , preferably 30 \leq x \leq 80 , \\ 1 \leq y \leq 30 , preferably 2 \leq y \leq 10 , \\ 0.4 \leq a \leq 1. . preferably 0.6 \leq a \leq 0.95 , \\ 0 \leq b \leq 0.6 , preferably 0.05 \leq b \leq 0.4 , \\ a + b = 1 ,$$

more preferably x+y+2≥13,
wherein a mixture comprising at least two different siloxanes that collectively have dimethylhydrosiloxy groups, methylhydrosiloxy groups, dimethylsiloxy groups and preferably trimethylsiloxy groups
is contacted with a macrocrosslinked water-containing cation exchange resin that contains sulfonic acid groups and left to react with rearrangement of the SiOSi bonds until the acid-free hydrosiloxane equilibrate produced in this way, in a precious metal-catalysed hydrosilylating addition onto at least one unsaturated polyether having a preferably arithmetic average HLB value>9.0 calculated by Guo's increment method, affords an addition product that is clear at T=25° C.,
wherein the rearrangement of the SiOSi bonds is implemented in the temperature range from 10 to 50° C., with the proviso that the macrocrosslinked water-containing cation exchange resin that contains sulfonic acid groups is characterized in that the product P of the specific surface area thereof and the average pore diameter thereof is P≥2.2×10⁻³ m³/kg and the specific surface area A is ≥35 m²/g, and in that it additionally has a water content of 6 to 16 per cent by weight, based on the weight of the cation exchange resin.

It is particularly preferable when the rearrangement of the SiOSi bonds is implemented in the temperature range from 30° C. to 40° C.

### DETAILED DESCRIPTION OF THE INVENTION

The rearrangement of the SiOSi bonds is preferably conducted within a period of 4 to 10 hours, preferably 5 to 8 hours.

Preferably, the process according to the invention, especially preferably the rearrangement of the SiOSi bonds, is conducted at a pressure preferably of 800 mbar to 1200 mbar, more preferably of 950 mbar to 1100 mbar.

It is preferable when it is a feature of the macrocrosslinked water-containing cation exchange resin that contains sulfonic acid groups that the product P of the specific surface area thereof and the average pore diameter thereof is P≥2.3×10⁻³ m³/kg, further preferably ≥2.4×10⁻³ m³/kg.

The macrocrosslinked, water-containing cation exchange resin that contains sulfonic acid groups preferably has an average pore diameter of at least 65 nm.

According to the invention, in the process for preparing acid-free hydrosiloxane equilibrates, a mixture comprising at least two different siloxanes that collectively have dimethylhydrosiloxy groups, methylhydrosiloxy groups, dimethylsiloxy groups and preferably trimethylsiloxy groups is used.

The mixture comprising at least two different siloxanes accordingly contains SiH-functional siloxane. SiH-functional siloxanes are siloxanes having at least one SiH function, i.e. one or more than one SiH function.

In the context of the present invention, usable siloxanes having dimethylsiloxy and methylhydrosiloxy groups are more preferably those containing fractions of trimethylsiloxy groups, since they can preferably be prepared using the poly(methylhydro)siloxane, which is available in sufficient industrial volumes and is trimethylsiloxy-endcapped at its chain termini.

Siloxanes, for example 2,4,6,8-tetramethylcyclotetrasiloxane (D₄^{H}), which are suitable according to the teaching of the invention for provision of methylhydrosiloxy groups, are among the specialty chemicals of lower industrial availability, but are likewise usable with preference.

It is preferably possible to use any of the siloxanes having at least one SiH function, preferably those in which the SiH functions are in purely terminal, purely pendant or mixed pendant and terminal positions in the siloxane.

The SiH-functional siloxanes used may preferably be, for example, 1,1,1,3,5,5,5-heptamethyltrisiloxane and/or higher homologues in the form of the trimethylsiloxy-terminated linear poly(methylhydro)siloxanes, for example HMS-993 from Gelest Inc. (Gelest Inc. in Morrisville, Pennsylvania, USA), and additionally, for example, linear polydimethylmethylhydrosiloxane copolymers, for example HMS-031 and/or HMS-071 from Gelest Inc., and additionally, for example, linear α,ω-dihydropolydimethylsiloxanes, for example 1,1,3,3-tetramethyldisiloxane, 1,1,3,3,5,5-hexamethyltrisiloxane and/or higher homologues, for example DMS HM15, DMS-H03, DMS-H25, DMS-H31 and/or DMS-H41 from Gelest Inc., and additionally, for example, cyclic poly(methylhydro)siloxanes, for example tetramethylcyclotetrasiloxane and/or pentamethylcyclopentasiloxane, and additionally, for example, cyclic polydimethylmethylhydrosiloxane copolymers, for example heptamethylcyclotetrasiloxane and/or nonamethylcyclopentasiloxane, or any mixtures thereof.

The SiH-functional siloxanes used may more preferably be poly(methylhydro)siloxanes, 1,1,3,3-tetramethyldisiloxane, DMS-H03, HMS-993 (each from Gelest Inc.) and/or pentamethylcyclopentasiloxane.

The SiH function-free siloxanes used may preferably be, for example, linear polydimethylsiloxanes, for example hexamethyldisiloxane, or else, for example, cyclic polydimethylsiloxanes, for example octamethylcyclotetrasiloxane and/or decamethylcyclopentasiloxane, more preferably hexamethyldisiloxane and/or decamethylcyclopentasiloxane.

In particular, it is preferable when the mixture comprising at least two different siloxanes that collectively have dimethylhydrosiloxy groups, methylhydrosiloxy groups, dimethylsiloxy groups and preferably trimethylsiloxy groups comprises at least one α,ω-dihydropolydimethylsiloxane and at least one poly(methylhydro)siloxane, preferably at least one poly(methylhydro)siloxane end-capped with trimethylsiloxy groups. When the siloxane mixture used additionally contains at least one cyclic siloxane, preferably selected from the group consisting of octamethylcyclotetrasiloxane (D₄), decamethylcyclopentasiloxane (D₅) and dodecamethylcyclohexasiloxane (D₆), this is particularly preferred. It is preferable to allow the previously obtained poly(methylhydrosiloxane)-polydimethylsiloxane copolymers bearing dimethylhydrosiloxy groups, preferably the acid-free hydrosiloxane equilibrates, to react under the conditions of a precious metal-catalysed hydrosilylation with at least one unsaturated polyether, preferably with a polyether mixture consisting of at least two unsaturated polyethers, and to visually assess whether this reaction gives rise to a visually clear addition product.

The at least one unsaturated polyether to be used here, preferably the mixture consisting of at least two unsaturated polyethers, has an HLB value of greater than 9.0, calculated by the increment system introduced by Guo et al. (Calculation of hydrophile-lipophile balance for polyethoxylated surfactants by group contribution method in J. Colloid Interface Sciences 298, (2006), 441-450). When multiple unsaturated polyethers are used, i.e. when a mixture consisting of at least two unsaturated polyethers is used, the arithmetic average HLB value (HLB=hydrophilic-lipophilic balance) of the unsaturated polyethers used is >9.0.

In the case of the polyethersiloxanes composed of different polyethers, it is preferably possible to find the arithmetic average HLB value by multiplying the molar percentage without excess of each polyether used in the respective polyethersiloxane recipe with its respective HLB value calculated according to Guo's system and then adding up these results for all the polyethers present in the polyethersiloxane.

In the context of the present invention, cloudy addition products (the addition products are polyethersiloxanes) show the presence of domains, whereas clear addition products demonstrate a very substantially statistical uniform distribution.

This finding is applicable to the polyethersiloxanes derived from the hydrosiloxanes having both pendant SiH in the form of methylhydrosiloxy groups and dimethylhydrosiloxy groups and dimethylsiloxy groups, and preferably also fractions of trimethylsiloxy groups.

This visual assessment can also be used when the hydrosiloxane to be assessed is intended, for example, for a completely different hydrosilylating modification than transformation to a polyethersiloxane, for example.

It is preferable that, during the process according to the invention for preparing acid-free hydrosiloxane equilibrates, a sample of the hydrosiloxane to be assessed is taken from the reaction mixture, and this sample is reacted under the conditions of a precious metal-catalysed hydrosilylation with at least one unsaturated polyether having an arithmetic average HLB value>9.0 calculated by Guo's increment method, and, after visual inspection of the clarity of the resultant addition product, a decision is made as to whether the process for preparing acid-free hydrosiloxane equilibrates can be ended.

If the resultant addition product is clear, the respective hydrosiloxane is suitable for further processing, for example to paint additives as well, and the process for preparing acid-free hydrosiloxane equilibrates can be ended.

It is preferable that, in order to end the process for preparing acid-free hydrosiloxane equilibrates, contacting the reaction mixture with the macrocrosslinked, water-containing cation exchange resin containing sulfonic acid groups is interrupted, in particular is prevented.

If the resultant addition product, by contrast, is cloudy, it is possible, for example, to continue the process for preparing acid-free hydrosiloxane equilibrates preferably until a clear addition product is obtained in the aforementioned procedure.

The visual assessment itself can be directly accomplished by simply viewing a sample at T=25° C. This can preferably be conducted by simple measures and reliably, for example, in a preparative laboratory. An illustrative method for visual assessment may, for example, be as follows: The addition product, i.e. polyethersiloxane, to be assessed is introduced with a layer thickness of about 10 mm at a temperature of 25° C. into a transparent glass sample vessel with a flat base, for example a beaker, or, for example, a snap-lid bottle, and the latter is then placed onto a white sheet of paper printed with black type in the Arial 12 font, and then the printed text is read through the filled glass vessel. If it is possible to read the text without difficulty and without perceptible distortion, the addition product, i.e. polyethersiloxane, should be regarded as clear and hence the hydrosiloxane used for hydrosilylation to have been impeccably equilibrated in accordance with the invention.

The visual assessment can preferably also be conducted by a group of at least 5, preferably at least 11, normal-sighted people. A simple majority decision by the group can then preferably define the result. Visual assessment by a group preferably enables any required compensation of the subjectivity of perception of a normal-sighted individual.

The hydrosilylation (i.e. the hydrosilylating addition) is preferably conducted in the presence of at least one precious metal catalyst, preferably selected from complexes and/or compounds of platinum, of rhodium, of osmium, of ruthenium, of palladium or of iridium, and/or preferably selected from the corresponding pure elements or the derivatives thereof immobilized on silica, alumina or activated carbon or similar support materials.

The hydrosilylation can preferably be conducted with the aid of at least one platinum complex, such as preferably cis-(NH₃)₂PtCl₂ (known as cis-platin) and/or di-μ-[chloro-bischloro(cyclohexene)platinum(II)]. The hydrosilylation can more preferably be performed with at least one complex of zero-platinum, for example [tris(divinyltetramethyldisiloxane)bisplatinum(0)] (Karstedt's catalyst).

The hydrosilylation can most preferably be conducted in the presence of at least one platinum(0) complex catalyst which, prior to addition to the reaction medium, is dissolved in a solvent, and the solution of which includes at least one added unsaturated hydrocarbon having 2 to 6 carbon atoms, preferably according to the teaching of EP 1520870 A1.

The amount of catalyst is preferably such that the total concentration of precious metal, preferably platinum, is 1 to 100 ppmw (ppm by weight), preferably 2 to 10 ppmw, based on the overall reaction mixture.

As will be apparent to those skilled in the art, the minimum precious metal concentration, preferably platinum concentration, is preferably chosen such that it permits a reliably rapid SiC bond-forming reaction without impairing the economic viability of the process by excessively high precious metal use or else, furthermore, causing disadvantageous product discoloration.

The hydrosilylation can preferably be conducted at temperatures between 0 and 200° C., preferably between 50 and 140° C.

The catalyst can be used over a wide temperature range in the hydrosilylation. For avoidance of side reactions, the temperature range is preferably chosen at such a low level that it constitutes an acceptable compromise between the desired product purity and production performance.

As already described, at least one unsaturated polyether is used in the noble metal-catalysed hydrosilylating addition.

Preferred unsaturated polyethers usable in the context of the precious metal-catalysed hydrosilylating addition are preferably those that conform to the formula (I):

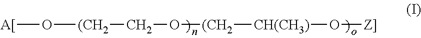

wherein
A is an olefinically unsaturated organic radical having at least two carbon atoms, preferably at least three carbon atoms, of an organic starter compound for provision of the polyether,
Z is either hydrogen, methyl-, ethyl-, propyl- or butyl-,
n=from 0 to 50, preferably from 9 to 30, more preferably from 10 to 22,
o=from 0 to 50, preferably from 1 to 20, more preferably from 2 to 13,
with the proviso that the sum total of n and o is equal to or greater than 1 and
with the proviso that the HLB value calculated for the unsaturated polyether according to Guo is >9.0.

The index values shown here and the ranges of values of the indices specified may preferably be regarded as averages (weight averages) of the possible statistical distribution of the actual structures present and/or the mixtures thereof. This preferably also applies to structural formulae reproduced per se exactly as such, for example to formula (I).

The units referred to by n and o may either be in a statistical mixture or else may be present in blocks in the chain. Statistical distributions may have a blockwise structure with any number of blocks and any sequence or they may be subject to a randomized distribution; they may also have an alternating structure or else form a gradient along the chain; in particular, they can also form any mixed forms in which groups of different distributions may optionally follow one another.

The unsaturated polyethers may preferably be prepared by alkoxylation reactions known from the prior art. Monomers used with preference in the alkoxylation reaction may preferably be ethylene oxide and/or propylene oxide, and any mixtures of these epoxides. The monomers may be used in pure form or in a mixture. The correlations between metered addition and product structure are known to those skilled in the art.

Particular preference is given to the polyethers of the formula (I) having a weight-average molar mass of 76 to 6000 g/mol, preferably of 100 to 4000 g/mol and more preferably of 200 to 2000 g/mol.

Starter compounds used for the alkoxylation reaction may preferably be any compounds of the formula (II)

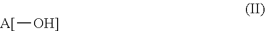

are used. The compounds of formula (II) have a hydroxyl group and A=olefinically unsaturated organic radical (as defined above). The olefinically unsaturated organic radical has at least two carbon atoms, preferably at least three carbon atoms. In the context of the present invention, starter compounds mean substances that form the beginning (start) of the polyether or alkoxylation product to be prepared, which is obtained by addition of alkylene oxides. The starter compound is preferably selected from the group of olefinically unsaturated alcohols. The starter compound used that contains the A group is preferably a monohydric olefinically unsaturated alcohol.

Particular preference is given to the radicals that derive from allyl alcohol, 1-hexenol, methallyl alcohol, vinyl alcohol and vinyloxybutanol, particular preference being given to the radical deriving from allyl alcohol. In the context of the teaching according to the invention, preferentially usable unsaturated polyethers are preferably ethylene oxide and/or propylene oxide derivatives of the unsaturated alcohols mentioned, and may, as well as the homopolymer structures derived solely from ethylene oxide (EO), also include the mixed EO/PO derivatives having an HLB>9.0.

Hydrosilylation as such is well known per se to the person skilled in the art from the prior art, for example the book “Chemie und Technologie der Silicone” [Chemistry and Technology of the Silicones], Verlag Chemie, 1960, page 43, and for example U.S. Pat. No. 3,775,452 and EP 1 520 870 A1.

The acid-free hydrosiloxane equilibrates obtainable in accordance with the invention are preferably stable, clear and colourless liquids that preferably contain at least only small proportions, if any, of volatile low molecular weight compounds.

Astonishingly, the present invention enables preparation of the hydrosiloxane equilibrates according to the invention with very substantial conservation of the SiH functionality, which is apparent, for example, from the comparison of the SiH equivalents previously weighed out in the reactant mixture to those SiH equivalents that can be determined analytically in the hydrosiloxane prepared by the process according to the invention.

The measured SiH equivalents are preferably in agreement within the accuracy of analysis, which can demonstrate that the SiH function used has been very substantially conserved.

It is preferable in accordance with the invention that the difference between the starting SiH content of the siloxanes used overall, meaning the SiH content determinable by gas volumetry prior to equilibration, and the final SiH content, i.e. the content of silicon-bonded hydrogen determinable by gas volumetry after equilibration, is ≤2 per cent.

The hydrosiloxanes according to the invention are acid-free, which, in the context of this present invention, preferably corresponds to a measurable acidity of ≤2 ppm, i.e. ≤2 mg KOH per kg of sample, preferably measured by an endpoint titration in which 30 g of the respective sample are weighed out accurately to 0.1 mg in a titration beaker, then dissolved in about 100 ml of ethanol, and 0.1 per cent bromophenol blue solution is added. The resultant yellow-coloured solution is titrated on a titroprocessor (for example from Metrohm) against 0.02 molar ethanolic KOH. The colour change recorded (to intense blue) indicates the end of the titration. The consumption of ethanolic potassium hydroxide solution and the starting weight can then be used to calculate the acid number.

The macrocrosslinked, water-containing cation exchange resin that contains sulfonic acid groups and is used in accordance with the invention, after the respective siloxane equilibrate has been separated off, is preferably suitable for further use as equilibration catalyst.

As already described above, in the process according to the invention for preparing acid-free hydrosiloxane equilibrates, the siloxane mixture is left to react with rearrangement of the SiOSi bonds until the acid-free hydrosiloxane equilibrate produced in this way, in a precious metal-catalysed hydrosilylating addition onto at least one unsaturated polyether having an arithmetic average HLB value>9.0 calculated by Guo's increment method, affords an addition product that is clear at T=25° C.

The clarity of the addition product is a simple and excellent way of assessing the equilibrated quality of the hydrosiloxane, as will be apparent in the examples section that follows further down. Even gas chromatography analysis, which is otherwise frequently used to assess the quality of siloxane equilibrates, reaches its limits here, as will also be apparent in the examples section that follows further down.

According to the invention, a macrocrosslinked, water-containing cation exchange resin that contains sulfonic acid groups is used. It has a water content of 6 to 16 per cent by weight, preferably 8 to 12 per cent by weight, based on the weight of the cation exchange resin. It may be preferable to add defined amounts of water to the reactant system, i.e. the mixture comprising at least two different siloxanes which collectively have dimethylhydrosiloxy groups, methylhydrosiloxy groups, dimethylsiloxy groups and preferably trimethylsiloxy groups, in order, for example, to counter possible water depletion of the sulfonic acid cation exchange resin.

The examples which follow serve merely to further elucidate the present invention and do not constitute any restriction of the present invention at all.

### EXAMPLES

In the examples section that follows, only the hydrosiloxanes (SiH siloxanes) that afford clear polyethersiloxanes in accordance with the invention are referred to as “hydrosiloxane equilibrate”. All other products are referred to in the examples section which follows by the term “hydrosiloxane”.

Unless explicitly stated otherwise, all per cent figures should be regarded as percentages by weight.

Water was determined in the sulfonic acid cation exchange resins by the Karl Fischer method in accordance with DIN 51777, DGF E-III 10 and DGF C-III 13a.

The acid numbers in the hydrosiloxane equilibrates or hydrosiloxanes were determined by an endpoint titration in the form of a double determination in which 30 g of the respective sample were weighed out accurately to 0.1 mg in a titration beaker, then dissolved in about 100 ml of ethanol, and 0.1 per cent bromophenol blue solution was added. The resultant yellow-coloured solution was titrated on a titroprocessor (from Metrohm) against a 0.02 molar ethanolic KOH solution. The colour change recorded (to intense blue) indicated the end of the titration. The consumption of ethanolic potassium hydroxide solution and the starting sample weight were then used to calculate the acid number.

The inventors point out that the polyethersiloxanes which were produced as described in the part that follows further down using Amberlyst®15 (average pore diameter 25 nm, surface area 45 m²/g) (Example 4) or Purolite® CT 169d (average pore diameter 24.0-42.5 nm, surface area 35-50 m²/g) (Example 5) as cation exchange resins are cloudy liquids. Important parameters for the description of the catalyst phases to be used in accordance with the invention are thus specific surface area and porosity, i.e. average pore diameter. If the two variables are used to form a product, this has the character of an inverse density (volume:mass) and permits clear differentiation of the ion exchangers that work in principle from those that are not to be used in accordance with the invention.

Inventive Example 1 makes use of Lewatit® K 2621, a macroporous sulfonic acid cation exchange resin having an average pore diameter of 65 nm and a specific surface area of 40 m²/g with a water loading of 11.6 per cent by weight, and leads to a hydrosiloxane equilibrate according to the invention.

Noninventive Example 2 likewise makes use of Lewatit® K 2621, except with adjustment of a cation exchange resin having a starting water loading of 11.6 per cent by weight by subsequent chemical drying to a noninventive water content of 3.2 per cent by weight. The use of this cation exchange resin results in a noninventive hydrosiloxane that affords a cloudy product after hydrosilylation to give the polyethersiloxane.

Even the gas chromatography analysis which is otherwise frequently utilized to assess the quality of siloxane equilibrates reaches its limits here, as shown further down in the following text by the comparisons of the siloxane cycle concentrations measured in the 5 hydrosiloxanes (see Examples 1 to 5); the D₄, D₅ and D₆ concentrations of the samples differ only minimally—with the exception of Example 4—and hence do not permit any conclusion as to the usability of the respective hydrosiloxane.

### Preparation of the Cation Exchange Resins Used for SiOSi Rearrangement

The sulfonic acid cation exchange resins Lewatit® K 2621 (Example 1), Amberlyst®15 (Example 4) and Purolite® CT169d (Example 5) were each placed in an open evaporation dish in a drying cabinet heated to 60° C. and then transferred in the still-warm state to inertized vessels with exclusion of moisture and stored. The Lewatit® K 2621 sulfonic acid cation exchange resin used in Example 2 with an original water content of 11.6 per cent by weight was adjusted by subsequent chemical drying, i.e. by reacting with trimethylchlorosilane according to the following reaction equation:

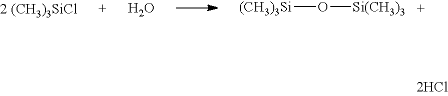

to a water content of 3.2 per cent by weight. For this purpose, under nitrogen inertization, the sulfonic acid cation exchange resin (Lewatit® K 2621) was contacted intensively with trimethylchlorosilane in a flask on a rotary evaporator at 22° C. with stirring for one hour. By applying an auxiliary vacuum (oil pump vacuum of 5 mbar), the volatiles were then drawn off, and the cation exchange resin that had thus been chemically predried was isolated and likewise stored with exclusion of moisture.

### Example 1 (According to the Invention)

38.5 g of an α,ω-dihydropolydimethylsiloxane (average chain length determined by gas volumetry N=9.82) formed an initial charge together with 37.6 g of a poly(methylhydro)siloxane endcapped with trimethylsiloxy groups (average chain length determined by gas volumetry N=42.9) and 173.9 g of decamethylcyclopentasiloxane (D₅) in a 500 ml four-neck round-bottom flask with precision glass stirrer, internal thermometer and a reflux condenser on top with stirring. The starting SiH content was determined from a weighed sample of this mixture as 2.790 val SiH/kg by gas volumetry on a gas burette (decomposition with a butanolic sodium butoxide solution). The siloxane mixture was then contacted with 6 per cent by weight (based on the total mass of siloxane) of a macroporous sulfonic acid cation exchange resin (Lewatit®K 2621, average pore diameter 65 nm, surface area 40 m²/g) that had been dried at 60° C. in a drying cabinet. The water content of the predried resin determined by Karl Fischer titration was 11.6 per cent by weight. Under nitrogen inertization, the reaction mixture was heated to 40° C. for 6 hours. Thereafter, the sulfonic acid resin was removed by filtration, and the equilibrated hydrosiloxanes was isolated as a colourless clear liquid.

In repetition of the gas volumetry conducted prior to commencement of the reaction, a weighed aliquot of the hydrosiloxane equilibrate was used to determine the final SiH content by gas volumetry in a gas burette (decomposition with a butanolic sodium butoxide solution). Within the scope of measurement accuracy, the final SiH value corresponded to the starting SiH value of 2.790 val SiH/kg.

An accompanying gas chromatography analysis showed, for the siloxane cycle contents present in the hydrosiloxane equilibrate: D₄=2.0%, D₅=1.1% and D₆=0.32%.

Determination of the residual acidity present in the hydrosiloxane equilibrate according to the acid number gave a value of <2 ppm.

### Example 2 (Noninventive)

### Use of a Chemically Predried Cation Exchange Resin With 3.2 Per Cent by Weight of Water

38.5 g of an α,ω-dihydropolydimethylsiloxane (average chain length determined by gas volumetry N=9.82) formed an initial charge together with 37.6 g of a poly(methylhydro)siloxane endcapped with trimethylsiloxy groups (average chain length determined by gas volumetry N=42.9) and 173.9 g of decamethylcyclopentasiloxane (D₅) in a 500 ml four-neck round-bottom flask with precision glass stirrer, internal thermometer and a reflux condenser on top with stirring. The starting SiH content was determined from a weighed aliquot of this mixture as 2.790 val SiH/kg by gas volumetry on a gas burette (decomposition with a butanolic sodium butoxide solution). The siloxane mixture was then contacted with 6% by weight (based on the total mass of siloxane) of a macroporous sulfonic acid cation exchange resin (Lewatit®K 2621, average pore diameter 65 nm, surface area 40 m²/g) that had been chemically predried to a water content of 3.2 per cent by weight (Karl Fischer titration). Under nitrogen inertization, the reaction mixture was heated to 40° C. for 6 hours. Thereafter, the sulfonic acid resin was removed by filtration, and the hydrosiloxane was isolated as a colourless clear liquid.

In repetition of the gas volumetry conducted prior to commencement of the reaction, a weighed aliquot of the hydrosiloxane was used to determine the final SiH content by gas volumetry in a gas burette (decomposition with a butanolic sodium butoxide solution). Within the scope of measurement accuracy, the final SiH value corresponded to the starting SiH value of 2.790 val SiH/kg.

An accompanying gas chromatography analysis attributed contents of D₄=1.9%, D₅=1.2% and D₆=0.31% to the siloxane cycles present in the hydrosiloxane.

Determination of the residual acidity present in the hydrosiloxane according to the acid number gave a value of <2 ppm.

### Example 3 (Noninventive Reference Example)

### Use of Trifluoromethanesulfonic Acid as Equilibration Catalyst

38.5 g of an α,ω-dihydropolydimethylsiloxane (average chain length determined by gas volumetry N=9.82) formed an initial charge together with 37.6 g of a poly(methylhydro)siloxane endcapped with trimethylsiloxy groups (average chain length determined by gas volumetry N=42.9) and 173.9 g of decamethylcyclopentasiloxane (D₅) in a 500 ml four-neck round-bottom flask with precision glass stirrer, internal thermometer and a reflux condenser on top with stirring. The starting SiH content was determined from a weighed aliquot of this mixture as 2.790 val SiH/kg by gas volumetry on a gas burette (decomposition with a butanolic sodium butoxide solution). The siloxane mixture was then admixed with 0.1 per cent by weight of trifluoromethanesulfonic acid (based on the total mass of siloxane). Under nitrogen inertization, the reaction mixture was heated to 40° C. for 6 hours. Thereafter, 2.0 per cent by weight of sodium hydrogencarbonate (based on the total mass of siloxane) was added, and the mixture was left to stir for 30 minutes. Then the solids were separated off by filtration, and the equilibrated hydrosiloxane was isolated as a colourless clear liquid.

In repetition of the gas volumetry conducted on commencement of the reaction, a weighed aliquot of the hydrosiloxane was used to determine the final SiH content by gas volumetry in a gas burette (decomposition with a butanolic sodium butoxide solution). Within the scope of measurement accuracy, the final SiH value corresponded to the starting SiH value of 2.78 val SiH/kg.

An accompanying gas chromatography analysis determined the siloxane cycle contents in the hydrosiloxanes as D₄=1.9%, D₅=1.1% and D₆=0.30%.

The residual acidity in the hydrosiloxane equilibrated, ascertained by acid value determination, was 9 ppm.

### Example 4 (Noninventive)

38.5 g of an α,ω-dihydropolydimethylsiloxane (average chain length determined by gas volumetry N=9.82) formed an initial charge together with 37.6 g of a poly(methylhydro)siloxane endcapped with trimethylsiloxy groups (average chain length determined by gas volumetry N=42.9) and 173.9 g of decamethylcyclopentasiloxane (D₅) in a 500 ml four-neck round-bottom flask with precision glass stirrer, internal thermometer and a reflux condenser on top with stirring. The starting SiH content was determined from a weighed aliquot of this mixture as 2.790 val SiH/kg by gas volumetry on a gas burette (decomposition with a butanolic sodium butoxide solution). The siloxane mixture was then contacted with 6 per cent by weight (based on the total mass of siloxane) of a macroporous sulfonic acid cation exchange resin (Amberlyst®15, average pore diameter 25 nm, specific surface area 45 m²/g) that had been dried at 60° C. in a drying cabinet. The water content of the predried resin determined by Karl Fischer titration was 10 per cent by weight. Under nitrogen inertization, the reaction mixture was heated to 40° C. for 6 hours. Thereafter, the sulfonic acid resin was removed by filtration, and the hydrosiloxane was isolated as a colourless clear liquid.

In repetition of the gas volumetry conducted on commencement of the reaction, a weighed aliquot of the hydrosiloxane was used to determine the final SiH content by gas volumetry in a gas burette (decomposition with a butanolic sodium butoxide solution). Within the scope of measurement accuracy, the final SiH value corresponded to the starting SiH value of 2.790 val SiH/kg.

An accompanying gas chromatography analysis determined the cycle contents in the hydrosiloxane as D₄=3.3%, D₅=2.3% and D₆=0.68%.

Determination of the residual acidity present in the hydrosiloxane according to the acid number gave a value of <2 ppm.

### Example 5 (Noninventive)

38.5 g of an α,ω-dihydropolydimethylsiloxane (average chain length determined by gas volumetry N=9.82) formed an initial charge together with 37.6 g of a poly(methylhydro)siloxane endcapped with trimethylsiloxy groups (average chain length determined by gas volumetry N=42.9) and 173.9 g of decamethylcyclopentasiloxane (D₅) in a 500 ml four-neck round-bottom flask with precision glass stirrer, internal thermometer and a reflux condenser on top with stirring. The starting SiH content was determined from a weighed aliquot of this mixture as 2.790 val SiH/kg by gas volumetry on a gas burette (decomposition with a butanolic sodium butoxide solution). The siloxane mixture is then contacted with 6% by weight (based on the total mass of siloxane) of a macroporous sulfonic acid cation exchange resin (Purolite® CT169d, average pore diameter 24.0-42.5 nm, specific surface area 35-50 m²/g) that had been dried at 60° C. in a drying cabinet. The water content of the predried resin determined by Karl Fischer titration is 13.1 per cent by weight. Under nitrogen inertization, the reaction mixture was heated to 40° C. for 6 hours. Thereafter, the sulfonic acid resin was removed by filtration, and the hydrosiloxane was isolated as a colourless clear liquid.

In repetition of the gas volumetry conducted on commencement of the reaction, a weighed aliquot of the hydrosiloxane was used to determine the final SiH content by gas volumetry in a gas burette (decomposition with a butanolic sodium butoxide solution). The final SiH value was 2.70 val SiH/kg.

An accompanying gas chromatography analysis determined the cycle contents in the hydrosiloxane as D₄=1.8%, D₅=1.0% and D₆=0.30%.

Determination of the residual acidity present in the hydrosiloxane according to the acid number gave a value of <2 ppm.

### Conversion of the Hydrosiloxane Equilibrates or Hydrosiloxanes Isolated in Examples 1 to 5 to the Polyethersiloxanes A to E

### General Procedure

60 g of the respective hydrosiloxane equilibrate or hydrosiloxane formed a stirred initial charge in each case together with a polyether mixture consisting of 38.8 g of an allyl alcohol-started hydroxy-functional poly(ethyleneoxy)poly(propenyloxy) ether having a molar mass of 615 g/mol and a propylene oxide content of 20% (calculated HLB value according to Guo=11.11) and 168.4 g of an allyl alcohol-started hydroxy-functional poly(ethyleneoxy)poly(propenyloxy) ether having a molar mass of 1144 g/mol and a propylene oxide content of 39% (calculated HLB value according to Guo=11.75) at 90° C. in a 500 ml round bottom flask with precision glass stirrer and a reflux condenser on top. The initially biphasic and cloudy reaction mixture was then admixed with 10 ppm of platinum in the form of the pulverulent cis-PtCl₂(NH₃)₂ complex. The arithmetic average HLB value according to Guo for the polyether mixture used is 11.56.

The hydrosilylating SiC bond formation to give the polyethersiloxane proceeded with slight exothermicity. All batches were left to run over a period of 150 minutes. After that time, samples were taken from all batches for the determination of the gas-volumetric SiH conversion in a gas burette (decomposition with a butanolic sodium butoxide solution). All batches attained quantitative SiH conversion.

At reaction temperature, the batches with introduction of the hydrosiloxane equilibrates that come from Example 1 and Example 3 (polyethersiloxanes A and C) have reached their respective clearing point after only 45 minutes (polyethersiloxane A) and after 50 minutes (polyethersiloxane C). The batch using the hydrosiloxane coming from Noninventive Example 2 (polyethersiloxane B), by contrast, remained cloudy even after a reaction time of 150 minutes.

The batches using the hydrosiloxanes coming from Examples 4 and 5 (polyethersiloxanes D and E) likewise remained cloudy at reaction temperature even after a reaction time of 150 minutes.

### The term “Clearing Point”

The reactions of the SiH siloxanes comprising hydrosiloxane equilibrates or hydrosiloxanes with unsaturated polyethers to give polyethersiloxanes (hydrosilylation) commence in biphasic form owing to the incompatibility of the reactants.

The increase in product concentration over the course of the reaction is accompanied by a decrease in the concentration of incompatible reactants, while the silicone polyether copolymer acts as a surfactant that promotes the dispersal of remaining incompatible reactant droplets at the phase interface, specifically of SiH siloxanes and also of the partly converted SiH siloxanes, in the polyether matrix. The clearing point observable in the SiC bond-forming preparation of silicone polyethers at reaction temperature is an indicator and consequence of this increasing phase dispersal occurring in the reaction system. At the clearing point, the diameter of the individual droplets of the incompatible dispersed phase has fallen below the wavelength of visible light and the previously cloudy reaction matrix appears as a homogeneous clear phase.

At 25° C., samples of the polyethersiloxanes A to E to be assessed were each introduced into glass sample vessels having a flat base with a layer thickness of about 10 mm, and these vessels were then placed onto a white sheet of paper printed with black type in the Arial 12 font and then the printed text was read through the filled glass vessel in each case. If it was possible to read the text without difficulty and without perceptible distortion, the polyethersiloxane was to be regarded as clear and hence the hydrosiloxane used for hydrosilylation to have been impeccably equilibrated in accordance with the invention.

### Visual Assessment of Polyethersiloxanes A to E

| | | |
|---|---|---|
| Polyethersiloxane A | Reaction from Example 1 | clear |
| Polyethersiloxane B | Reaction from Example 2 | cloudy |
| Polyethersiloxane C | Reaction from Example 3 | clear |
| Polyethersiloxane D | Reaction from Example 4 | cloudy |
| Polyethersiloxane E | Reaction from Example 5 | cloudy |

1. A process for preparing an acid-free hydrosiloxane equilibrate of the following average structural formula: 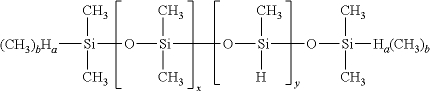
wherein
$$3 \leq x \leq 100 , \\ 1 \leq y \leq 30 , \\ 0.4 \leq a \leq 1. , \\ 0 \leq b \leq 0.6 , \\ a + b = 1 ,$$
the process comprising:
contacting a mixture comprising at least two different siloxanes that collectively comprises a dimethylhydrosiloxy group, a methylhydrosiloxy group, and a dimethylsiloxy group with a macrocrosslinked water-containing cation exchange resin that comprises a sulfonic acid group and reacting with rearrangement of a SiOSi bond until the acid-free hydrosiloxane equilibrate is produced, wherein the acid-free hydrosiloxane equilibrate in a metal-catalysed hydrosilylating addition onto at least one unsaturated polyether comprising an arithmetic average HLB value>9.0 calculated by Guo's increment method, affords an addition product that is clear at T=25° C.,
wherein the rearrangement of the SiOSi bond is implemented in the temperature range from 10 to 50° C.,
with the proviso that the macrocrosslinked water-containing cation exchange resin that comprises the sulfonic acid group wherein a product P of the specific surface area thereof and the average pore diameter thereof is P≥2.2×10⁻³ m³/kg and the specific surface area A is ≥35 m²/g, and further comprises a water content of 6 to 16 per cent by weight, based on the weight of the cation exchange resin.

2. The process according to claim 1, wherein the rearrangement of the SiOSi bond is implemented in the temperature range from 30° C. to 40° C.

3. The process according to claim 1, wherein the rearrangement of the SiOSi bond is conducted within a period of 4 to 10 hours.

4. The process according to claim 1, wherein a sample of the hydrosiloxane to be assessed is taken from the reaction mixture, and the sample is reacted under the condition of a metal-catalysed hydrosilylation with the at least one unsaturated polyether comprising the arithmetic average HLB value>9.0 calculated by Guo's increment method, and wherein the process for preparing the acid-free hydrosiloxane equilibrates can be ended after visual inspection of the clarity of the resultant addition product.

5. The process according to claim 1, wherein the process for preparing the acid-free hydrosiloxane equilibrate is ended by stopping the contacting of the reaction mixture with the macrocrosslinked water-containing cation exchange resin that comprises the sulfonic acid group.

6. The process according to claim 1, wherein the at least one unsaturated polyether comprises the formula (I): 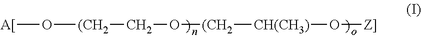
wherein
A is an olefinically unsaturated organic radical comprising at least two carbon atoms of an organic starter compound for provision of the polyether,
Z is either hydrogen, methyl-, ethyl-, propyl- or butyl-,
n=from 0 to 50,
o=from 0 to 50,
with the proviso that the sum total of n and o is not less than 1 and that the HLB value calculated by Guo's increment method is >9.0.

7. The process according to claim 1, wherein the macrocrosslinked water-containing cation exchange resin that comprises the sulfonic acid group comprises a water content of 6 to 16 per cent by weight, based on the weight of the cation exchange resin.

8. The process according to claim 1, wherein the macrocrosslinked water-containing cation exchange resin that comprises the sulfonic acid group comprises the product P of the specific surface area thereof and the average pore diameter thereof is P≥2.3×10⁻³ m³/kg.

9. The process according to claim 1, wherein the macrocrosslinked water-containing cation exchange resin that comprises the sulfonic acid group comprises an average pore diameter of at least 65 nm.

10. The process according to claim 1, wherein the mixture comprising at least two different siloxanes that collectively comprises the dimethylhydrosiloxy group, the methylhydrosiloxy group, and the dimethylsiloxy group comprises at least one α,@-dihydropolydimethylsiloxane and at least one poly(methylhydro)siloxane.

11. The process according to claim 10, wherein the mixture further comprises at least one cyclic siloxane.

12. The process according to claim 1, wherein the difference between the starting SiH content of the siloxane used overall, meaning the SiH content determinable by gas volumetry prior to equilibration, and the final SiH content is ≤2 per cent.

13. The process according to claim 1, wherein the acid-free hydrosiloxane equilibrates comprises a measurable acidity of ≤2 ppm KOH per kg.
